(19) United States
(12) Patent Application Publication
(10) Pub. No.: US 2025/0043578 A1
(43) Pub. Date: Feb. 6, 2025

(54) ROOF LADDER SUPPORT DEVICE AND METHODS OF USE

(71) Applicant: Rash Bar LLC, Niantic, CT (US)

(72) Inventor: Jason Ferellec, Niantic, CT (US)

(21) Appl. No.: 18/795,078

(22) Filed: Aug. 5, 2024

Related U.S. Application Data
(60) Provisional application No. 63/530,764, filed on Aug. 4, 2023.

(51) Int. Cl. E04G 3/22

(52) U.S. Cl. CPC E04G 3/22

(57) ABSTRACT

A device and related methods of use may be used to aid in supporting an individual, equipment, or tools from a ladder or similar device or independently. The device may be removably attached to the ladder or similar device and may, optionally, further optionally at least partially rest against a roof. When a user, such as a firefighter, needs to be on a roof, such as when cutting steep angle roof ventilation holes or vertical ventilation holes, the user may stand or apply force or weight or rest equipment at least partially on the device. The device may provide a larger or more stable area for supporting the firefighter or equipment than with conventional and currently available methods and tools. The device may also optionally be lockable to a ladder, may have gripping features or surfaces, and may be configured to retain tools such as saws or roofhooks.

### BACKGROUND

This application claims priority to U.S. Provisional Application No. 63/530,764, filed on Aug. 4, 2023, and titled “Roof Ladder Support Device and Methods of Use”, which is hereby incorporated by reference in its entirety.

The present disclosure relates generally to a device for aiding in supporting a user or equipment in connection with a structure, and related methods of use. More particularly, the present disclosure relates to a reusable device which may be removably connected to a second device or support structure, such as a ladder. The present disclosure further relates to a method wherein a user may connect a device to a ladder, such as a roof ladder used by firefighters, and support themselves at least partially on the device while creating holes in a roof, such as for vertical ventilation, or otherwise support themselves as needed.

When dealing with buildings that are on fire or that have high levels of smoke or other dangerous gases within, firefighters often have to cut holes in the roof of a building. This is often called vertical ventilation and is the process of removal of super-heated toxic gases and smoke by allowing those gases to continue upward and away from the building, through their normal upward path. Firefighters will put a roof ladder on top of a roof or leaning against it, then uses chainsaws and other tools to make an opening in the roof. This not only involves sounding multiple locations on the roof with a roofhook or other long tool, but it further requires maintaining balance while holding a very large and heavy powered saw.

This is a scenario which arises on many roofs, and can be extremely dangerous, as a loss of footing can lead to life-threatening accidents, and the roof itself can be wet, burning, or structurally compromised in various ways. This becomes even more dangerous when dealing with the many roofs that are at steep angles.

The firefighter will typically stand on a ladder on the roof with one foot, while having the other foot either directly on the roof or on a roofhook or Halligan tool, similar to a large crowbar, embedded in the roof. This requires the additional prior embedding of the tool into the roof, as best able, while essentially hanging far off the edge of the ladder and attempting to find a spot on the roof which can both be penetrated by the tool and offer sufficient support for needed loaded activities. The firefighter will hope to find a strong spot, like a ridge or valley of the roof, which is also close to where they are trying to cut through the roof. They will hope to be able to get a good footing on a very narrow piece of metal shaft of the tool, and this is only after hopefully successfully performing the difficult action with the Halligan tool.

The Halligan tool needs to be swung into the roof and then pounded in with an axe or other tool, all the while attempting to maintain balance on the ladder, hold on to the ladder with one arm with a strong grip, and extend far enough off of the ladder to reach a desired location. This is a very dangerous and difficult procedure, all being performed multiple stories up above the ground. Once successful, the tool still only gives a firefighter a few inches to place their foot. The firefighter, in large boots, is then having to cut through the roof, while having their foot slip, realigning their stance and footing, pulling muscles, and potentially encountering even more danger.

The only current alternative to roof ladder work of this nature is to use an aerial, such as on a ladder truck. This requires extensive coordination between the firefighter doing the cutting and the operator of the truck and turntable, and is often not actually feasible. This also very much limits what can be done, how quickly, and in how many locations.

Current devices and methods of use for supporting a user while connected to a structure, such as a firefighter using a roof ladder while attempting to cut steep angle roof ventilation holes, do not adequately support the firefighter and create substantial and life-threatening danger to those individuals. Current devices and methods require a firefighter to be substantially unsupported while attempting to create a small foothold. Current devices and methods are slow and not reliable. Once a foothold is created, current devices and methods leave a firefighter at risk of slipping and may lead to severe injuries even without falling, such as pulled muscles or injuries directly related to losing control or balance while using a large, heavy, cumbersome powered saw or needing to support a similar or even greater weight. There is a need for a product and associated method of use which will give firefighters a stable footing while creating vertical ventilation holes in roofs during a fire, which can be quickly deployed, which are reliable, which are safe, and which are easy to use even in the midst of fire, smoke, and high tension situations.

### SUMMARY

The present disclosure relates generally to a device for aiding in supporting a user or equipment in connection with a structure, and related methods of use. More particularly, the present disclosure relates to a reusable device which may be removably connected to a second device or support structure, such as a ladder. The present disclosure further relates to a method wherein a user may connect a device to a ladder, such as a roof ladder used by firefighters, and support themselves at least partially on the device while creating holes in a roof, such as for vertical ventilation. In particular, the present disclosure related to a device which is configured to be removably attached to a range of standard roof ladders. The device is configured to connect in a way that is easy to learn and to operate even during fires and high stress, low visibility situations. The present disclosure relates to a device that can provide reliable and substantial footholds to a firefighter even when roof integrity and other typical or prior necessities may otherwise be lacking.

The support device may include a structural connection feature which may be configured to removably connect to a structure, such as a ladder. The structural connection feature may attach to the sides or walls of the ladder, or may connect to one or more rungs of the ladder. In one embodiment, the structural connection feature is an elongated member. In another embodiment, the structural connection feature is a shaft. The shaft may be configured to at least partially fit within or, optionally, fit through, a hole in a rung of a ladder.

The support device may include a foot support feature. The foot support feature may be offset from the ladder, or a portion or feature of the ladder. When the support device is removably connected to the ladder, the foot support feature may have its distance relative to the ladder be adjustable, such that a user standing on the foot support feature with one foot may be able to select a desired distance from the ladder itself.

In some embodiments, the structural connection feature may be rotatably connected to the ladder. In other embodiments, the structural connection feature may be slidably connected to the ladder. Where the structural connection feature is optionally slidably connected to the ladder, the structural connection feature may be configured to pass through a rung of the ladder. The structural connection feature may optionally be configured to receive tools, such as a saw or an axe, so as to support the one or more tools when not being actively used by a user of the device.

The support device may include a support cage, which may itself have a foot support feature. The foot support feature may, in some embodiments, be a surface of the support cage. The surface of the cage configured to support a user's foot may have one or more protrusions, such as nubs or teeth to aid in gripping a user's foot, or may have a tread such as a diamond pattern or other pattern or gripping surface or feature.

In addition, or in some alternate embodiments, the cage may define one or more openings, such as configured to aid in drainage of liquids from one or more surfaces of the cage or from an interior of the cage. The one or more openings may be on the surface of the cage configured to support a user's foot, may be on one or more other surfaces of the support cage, may be on both the support surface and another surface, or may be entirely absent.

The support cage may have at least one feature or face which is configured to rest at least partially against a surface of a roof. This feature or face may be optionally at least partially open, such as to allow for pressing the cage against a variety of uneven surfaces, such as roof tiles. The support cage may also or alternatively optionally include one or more tooth protrusions configured to be pressed against a roof and to aid in resisting motion of the cage relative to the roof.

The support cage may be a range of shapes when viewed through a cross-section. The support cage may be substantially triangular in cross-section, may be substantially rectangular in cross-section, may be substantially trapezoidal in cross-section, may be a compound shape in cross-section, or may be other shapes in cross-section, including varying along the length of the support cage.

The shaft of the support device may define a point at an end, such as at the end distal to the support cage. The point may be conical and may be wedge-shaped, such as a chisel point. The end of the shaft that is distal to the support cage may include one or more recesses or tines, such as a fork feature, which may be present in a chisel end or in the absence of a chisel end.

The shaft of the support device may include a locking feature which may be configured to resist motion of the shaft relative to the ladder once the support device is in a desired position or orientation.

In some embodiments, the support device may include a handle. The handle may be attached to or part of the support cage, may be attached to or part of the shaft, or may extend between elements of one or both of the support cage and the shaft.

In one method of use, a user, such as a firefighter, may place at least a portion of the shaft of the support device at least partially within the hole of a rung of a ladder. The user may adjust the location of the support cage feature of the device to a desired distance or offset from the ladder. The user may stand on the support cage feature of the device, upon a surface of the cage, with one foot. The user may cut an opening in a roof of a building.

In a further method of use, the ladder may be placed against the roof of a building. This may be done before the device is removably connected to the ladder, or it may be done afterwards.

The user may orient a second gripping surface of the support cage against the roof, such as to aid in resisting motion of the support cage relative to the roof.

The device may be locked in a position or orientation relative to the ladder. This may be done through means of a locking feature on the device, on the ladder, on both, or through relative sizing, such as through a press fit or due to the length of the shaft and pressure exerted on the ladder.

The support surface of the cage, as well as optionally other surfaces of the cage, may include one or more protrusions configured to improve the traction and grip of a user's foot on the cage. Additionally in some embodiments, or optionally alternatively in some embodiments, the support surface of the cage and/or other surfaces of the cage may define one or more openings, such as to aid in the draining of liquid from the device.

The disclosure relates to a device and associated methods of use, such as through the use of the described invention. The methods may include the use of a device which may include one or more of the features or components described herein. Any number of components or features may be used in conjunction with and incorporated into the device described. Various materials, including metals, plastics, glass, epoxy, resin, rubber, and composites, may be used for the described components and features. The device may be substantially or partially made of substantially rigid material, may be made of combinations of materials, or may feature limited flexible materials, if any.

It is to be understood that the above mentioned features and the features yet to be explained hereinafter can be used not only in the respectively mentioned combinations but also in other combinations or alone without departing from the context of the present invention or intent of the present disclosure.

### BRIEF DESCRIPTION OF THE DRAWINGS

The invention is now disclosed in detail with reference to exemplary embodiments shown in the accompanying drawings, where:

FIG. 1 shows a top left isometric view of an embodiment of a stabilizing bar of the present disclosure;

FIG. 2 shows a bottom right isometric view of the embodiment of the stabilizing bar of FIG. 1;

FIG. 3 shows a bottom view of the embodiment of the stabilizing bar of FIG. 1;

FIG. 4 shows a top right isometric view of the embodiment of the stabilizing bar of FIG. 1, in an environment where it is removably connected to a roof ladder;

FIG. 5 shows a top left isometric view of an alternate embodiment of a stabilizing bar of the present disclosure;

FIG. 6 shows a bottom right isometric view of the embodiment of the stabilizing bar of FIG. 5;

FIG. 7 shows a bottom view of the embodiment of the stabilizing bar of FIG. 5;

FIG. 8 shows a top left isometric view of another embodiment of a stabilizing bar of the present disclosure;

FIG. 9 shows a bottom right isometric view of the embodiment of the stabilizing bar of FIG. 8;

FIG. 10 shows a top view of the embodiment of the stabilizing bar of FIG. 8;

FIG. 11 shows a partial bottom right isometric view of an alternate embodiment of the stabilizing bar of the present disclosure;

FIG. 12 shows a partial top left isometric view of another embodiment of the stabilizing bar of the present disclosure;

FIG. 13 shows a partial top left isometric view of an alternate embodiment of the stabilizing bar of the present disclosure;

FIG. 14 shows a top left isometric view of another embodiment of the stabilizing bar of the present disclosure;

FIG. 15 shows a partial bottom right isometric view of an alternate embodiment of the stabilizing bar of the present disclosure; and

FIG. 16 shows a top left isometric view of another embodiment of the stabilizing bar of the present disclosure.

### DETAILED DESCRIPTION

Exemplary embodiments of the disclosure are illustrated in the Figures and are explained in the following description in more detail, wherein identical, or similar, reference numbers refer to identical, or similar, or functionally identical or similar components or features.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

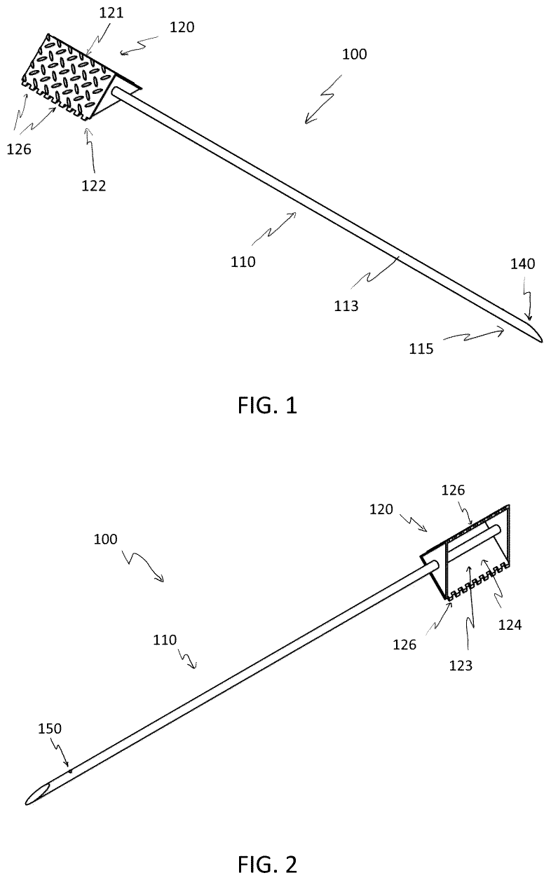

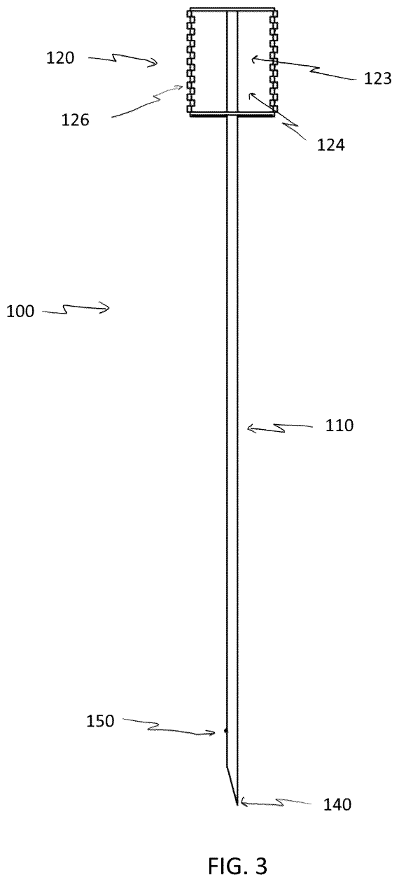

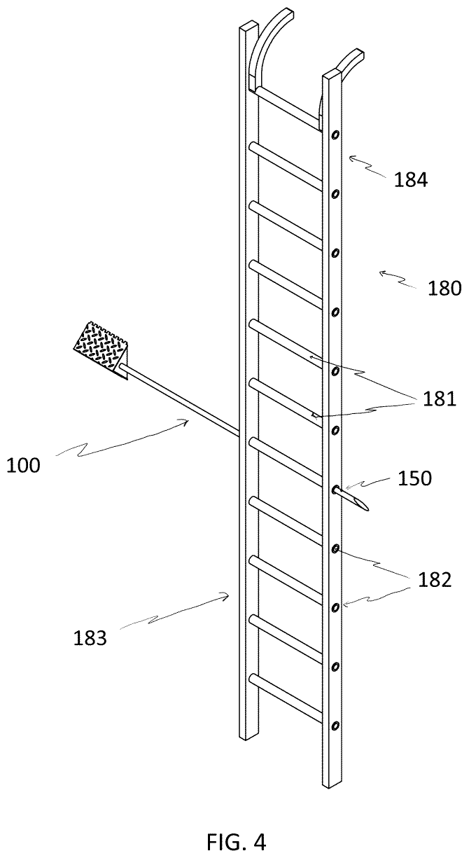

An embodiment of a stabilizing bar 100 is shown in FIGS. 1-4. The stabilizing bar 100 is herein referred to as a bar 100, though it should be understood that this does not necessarily require that the device 100 be substantially elongated or substantially cylindrical. Features of the bar 100 are herein described, and other shapes which functionally perform the roles herein described should be understood to fall within the design and intent of this disclosure. The device is further referred to herein as a stabilizing bar 100 for the purpose of convenience, though it should be understood that it may provide at least partial support for a user or for other devices or tools without strictly falling within the definition of stabilizing and still be within the intent and scope of this disclosure.

The stabilizing bar 100 may be made of a range of materials, such as metals such as steel and specifically 316 stainless steel, may be made of ceramics, may be made of temperature resistant resin, may be made of plastic, may be made of rubber or rubber-like compounds and materials, or may be made of any other material, including composite materials, which has or have sufficient strength required for the intended use and which has or have sufficient temperature resistance or corrosion resistance for environments likely to be encountered during the intended use. Further, the stabilizing bar 100 may be substantially made of only one material or composite material, or may be made of multiple materials, such as where different components of the stabilizing bar 100 are made of different materials or have different coatings or finishes. The stabilizing bar 100 may be substantially or entirely monolithic, or the stabilizing bar 100 may be made of multiple components. The stabilizing bar 100, or components of the stabilizing bar 100, may be machined, may be molded or partially molded with secondary machining, may be made through additive manufacturing, may be extruded, may be pressed, may be bent, may be stamped, or may be made using other manufacturing means known in the art. Where multiple components are present in the stabilizing bar 100, and where these components are attached to each other, components may be removably connected or may be non-removably connected.

Components may be connected through welding, snap fits, press fits, mechanical connection features, mechanical retention features, sintering, through the use of adhesives, or through other means known in the art.

The stabilizing bar 100 may include a connection feature 110. This connection feature 110 may be configured to removably connect to various structures, such as to a roof, to a ladder, to a truck, to a scaffold, or other items. As shown, the stabilizing bar 100 is configured to attach to a ladder 180 through the connection feature 110. In the embodiment shown, the stabilizing bar 100 includes a shaft 110 with an outer surface 113. The shaft 110 is configured to fit at least partially within, or through, a rung 181 of a ladder 180, such as a roof ladder 180. The shaft 110 may have a diameter of ⅞″, or may be larger or smaller in diameter. The shaft 110 may be configured to fit within rungs 181 of standard ladders, or may come in different diameters to be compatible with different ladders. The shaft 110 may be used in conjunction with one or more adapters, such as generally ring-shaped or tubular adapters, in order to fit within different rung 181 or rung opening 182 sizes or connect to different ladders 180, or the shaft 110 may have different graduated or otherwise varying diameters to enable connection to different ladders. Though the shaft 110 is shown as being substantially uniform in diameter in this embodiment, it should be understood that the shaft 110 may vary in diameter without deviating from the scope or intent of this disclosure, such as to enable initial easy insertion into a run hole 182 of a ladder 180, leading to a depth stop or light press fit at a desired limited depth into or through the run 181 or ladder 180. Further, though the shaft 110 is shown herein as being substantially cylindrical in cross-section, it may be of different shapes in cross-section, such as rectangular, triangular, pentagonal, hexagonal, octagonal, elliptical, hybrid shapes, irregular or asymmetrical shapes, or other shapes. Additionally, the shaft 110 may entirely or partially include a keying feature, such as to aid in alignment or aid in retention of the stabilizing bar 100 relative to the ladder 180. The shaft 110 may be substantially solid, may be made of multiple components, may be unitary, or may be at least partially hollow. In some embodiments, hollow galvanized piping may optionally be used to manufacture the shaft 110. In some optional further embodiments, the shaft 110 made be made at least partially of a hollow tube, with other components, such as a chisel tip 140, being attached, such as by welding.

In the embodiment shown, the shaft 110 includes a chisel tip 140, configured to aid in piercing sections of a roof or to pry things apart or open. This may be used with manual force or with the aid of tools, such as a hammer, sledge hammer, slap hammer 190, axe, or powered tool. The chisel 140 may also function to aid in aligning the distal end 115 of the shaft 110, and thus the shaft 110 itself, with the hole 182 of a rung 181 of a ladder 180. In some embodiments, the tip 140 of the shaft 110 may not be a chisel shape, but may be substantially or partially conical, such as to aid in insertion into a ladder rung 181 or rung hole 182, or may be at least partially flat, chamfered, filleted, or rounded.

The shaft 110 may be of various lengths. In some embodiments, the length of the shaft 110 between the step cage 120, described below, and the opposing end 115 may be 52″. This distance may also be the distance between the step cage 120 and a locking feature 150 of the shaft 110 or other specified area of the shaft 110. It should be understood that the shaft 110, or portions of the shaft 110, may be longer or shorter without deviating from the scope or intent of this disclosure. In some embodiments, the shaft 110 or the entire device 100 may be 45″ in length or less, and in other embodiments the shaft 110 or the entire device 100 may be 61″ or more, or the shaft 110 or device 100 may be any length in between. Different types of ladders 180, or different structures to which the stabilizing bar 100 is intended to be connected, may give rise to needs or preferences for different lengths of shaft 110. Additionally, shafts 110 which may be intended to not only support a user but also to support a range of equipment or tools may also be different lengths. The length of the shaft 110, and the various dimensions of the stabilizing bar 100 or features or components of the stabilizing bar 100 described herein, should not be considered limiting for the purpose of this disclosure. The shaft 110 may be partially or substantially smooth, may include surface features, roughing, or finishes, such as knurling, or may include a coating, such as an anodize coating or a rubber or rubber-like coating, or may be painted.

In the embodiment shown, the stabilizing bar 100 includes a locking feature 150. As shown, the locking feature 150 is a push button spring clip or spring button or nub located on the shaft 110, where a feature of the locking button 150 may at least partially rise up after the locking feature 150 is passed through the rung 181 of a ladder 180, leading to resisting the stabilizing bar 100 from unintentionally disconnecting from the ladder 180. When a user wishes to remove the stabilizing bar 100 from the ladder 180, the push button lock 150 may be at least partially depressed and the shaft 110 may be slidably removed from the ladder 180. It should be understood that other locking features 150, such as quick connects, push pins, mechanical locks, and other means known in the art, may be used without deviating from the scope or intent of this disclosure. In one alternate embodiment, the shaft 110 may include a detent and a carbiner-like clip that comprises an arm and recess, where an arm may open out or into to a recess to function as a locking feature 150. Further, the stabilizing bar 100 may resist motion through a light press fit, may optionally have more than one locking feature 150, may have multiple locking features 150 to connect to different ladders 180 or other support structures, may have multiple features 150 to enable the retention of different tools to the device 100, or may have no locking features 150 at all.

The stabilizing bar 100 may include one or more step cages 120, which may be connected to the shaft 110, such as by means of welding or threading, or may be unitary or monolithic with the shaft 110. Though the step cage 120 is herein referred to as a “cage”, this is for simplicity of terminology and should not be inferred to required cage-like properties in all embodiments. The step cage 120 may be considered a step base 120, and the base 120 may be fully or partially hollow or may be solid. The base 120 may include partial or complete through-holes, such as for drainage, weight reduction, or cleaning, or may be substantially without openings. As shown, the step cage 120 is substantially triangular in cross-section, though it should be understood that other shapes, such as rectangles, trapezoids, pentagons, hexagons, octagons, or hybrid shapes, may also or alternatively be used. The step cage 120 may be made of steel, aluminium, rubber, composite or hybrid materials, or other materials known in the art. Similarly, the step cage 120 may be have multiple layers, such as diamond plate steel, or may have surface finishes or coatings, such as rubber or rubber-like coatings, anodizing, knurling, or other similar processes to aid in protection against the environment or to aid in foot grip retention of a user. Versions of the stabilizing bar 100 which have the step cage 120, or elements of the step cage 120, made of steel or other substantially hard materials, may be used for roofs such as wood or where at least partial penetration into the roof may be desirable. Versions of the stabilizing bar 100 which have the step cage 120 made of rubber or other softer materials, or may have rubber or other softer material components or coatings, may be used for roofs made of materials such as metal or terracotta. Other versions of the step cage 120 may have some features or surfaces made of steel or similar materials and other features or surfaces made of rubber or similar materials.

The step cage 120 may be substantially hollow, as shown, and may optionally have a partially or substantially open face 123, or may be solid or substantially solid, or may be substantially or partially hollow, including wherein it may be entirely enclosed or enclosed except for openings 332, such as for drainage or to reduce weight.

In the embodiment shown, the step cage 120 includes a side 123 which defines an opening 124. This opening 124, during usage of the stabilizing bar 100, may be placed against a surface, such as a roof, even when that surface may not be perfectly flat or planar. The step cage 120 may, optionally, include one or more gripping teeth 126, as shown. The gripping teeth 126 may be substantially rectangular, as shown, may be at least partially flat, may be round or filleted, chamfered, or curved, or may be sharp, such as with triangular tips, or may be entirely absent without deviating from the scope or intent of this application.

As shown, the step cages includes two outer surfaces 121, 122 which have a diamond plate, tread plate, or diamond lug pattern. Such a surface finish or surface features may aid in improving traction of grip of a user on the step cage 120. It should, however, be understood that other traction-improving features may additionally or alternatively be present, such as a step foot recess, other patterns, or rubberized or other coatings, or partial or complete through holes. Alternatively, the step cage 120 might only have such a traction-improving feature on one side 121 or surface, instead of multiple sides 121, 122, 123 or surfaces, or might optionally not have any such feature at all.

As shown, the step cage 120 includes a plurality of gripping teeth 126. These teeth 126 may be located only on one side 121, may be be on two sides 121, 122, as shown, may be on multiple sides or surfaces, or may be optionally entirely absent. The gripping teeth 126 may be made of the same material as the rest of the step cage 120 or may be made of a different material. Where present, the gripping teeth 126 may all be made of the same material, or different surfaces or sides 121, 122 of the step cage 120 may include gripping teeth 126 made of different materials, such as to be used on different types of roofs.

In the embodiment shown, the shaft extends to an inner end of the step cage, through the inside of the step cage, and to an outer end of the step cage. In some embodiments, the shaft may extend past the outer end of the step cage, such as to provide a location for hanging tools such as saws, or another feature may be present to aid in retaining tools. The shaft may pass through the open volume of the step cage to provide structural support to the step cage, or the shaft might not enter the step cage at all. Where the does not pass through the step cage, one or more other structures or features may provide support or rigidity to the step cage, though these are optional and may be entirely absent.

In some embodiments, the step cage 120 may be 9″ long and the outer surfaces may be 5″ wide, so as to provide substantial support for a user's foot, such as where a user may be wearing firefighting boots. In other embodiments, the step cage 120 may be different dimensions, such as 8″ across, less than 8″, or more than 8″, and the sides may be of widths such as 4.5″, less than 4.5″, or more than 4.5″. It should be understood that the step cage 120 may be larger or smaller, in any one dimension or in multiple dimensions, without deviating from the scope or intent of this disclosure. In one method of use of the embodiment shown, a user may place a roof ladder 180 on, against, or adjacent to a roof. The stabilizing bar 100 may be already attached to the ladder 180, or the user may carry the stabilizing bar 100 with them while they climb the ladder 180. Upon reaching a desired height or location on the ladder 180, the user may connect the stabilizing bar 100 to the ladder 180, such as by sliding the shaft 110 of the stabilizing bar 100 from a first side 183 of the ladder 180 into and through a hole 182 of a rung 181 of the ladder 180. The user may slide the shaft 110 to a desired depth in the ladder 180, such as through to at least partially exit through a second side 184 of the ladder 180, or otherwise move it 110 so as to position the step cage 120 and, by extension, the entire device 100, in a desired location. The stabilizing bar 100 shaft 110 may optionally be locked into position. A user may then step at least partially onto the step cage 120 of the stabilizing bar 100. The user may then proceed to cut one or more holes in the roof, such as vertical ventilation holes and such as through the use of a saw, chainsaw, axe, Halligan tool, or other tool.

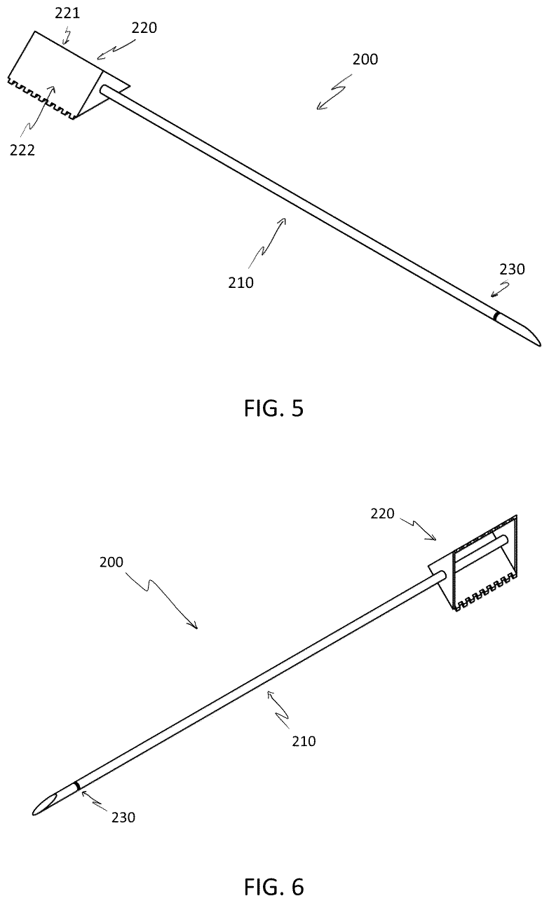

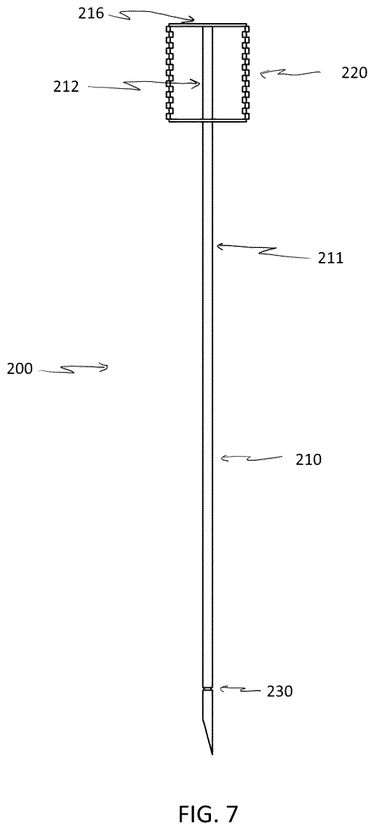

An alternate embodiment of the stabilizing bar 200 is shown in FIGS. 5-7. In this embodiment, the step cage 220 does not include any traction features on any of the outer surfaces 221, 222. The shaft 210 in this embodiment includes an optional detent 230 or recess which may connect to a complementary locking feature attached to the ladder 180. Alternatively, the detent 230 may be used to aid in showing a recommended depth of location of the shaft 210 within the ladder 180, such as to show a minimum recommended depth to support a user, equipment, or a user carrying an anticipated load. In other embodiments, other forms of marking may optionally be used to show recommended depths or to show different locations along the length of the shaft 210. In some embodiments, there may be a detent 230, or there may be a proud feature, such as a ring-like shape, or there may be a painted or anodized marking, or an area which has not been painted or anodized, or otherwise in contrast with the surrounding portions of the shaft 210.

In the embodiment shown, the shaft 210 may have an exterior portion 211 which extends outside of the step cage 220 and also an interior portion 212, which may be completely or partially within the step cage 220. It should be understood that, in other embodiments, the shaft 210 may only extend outside of the cage 220, or may extend out the proximal side 216 of the cage 220.

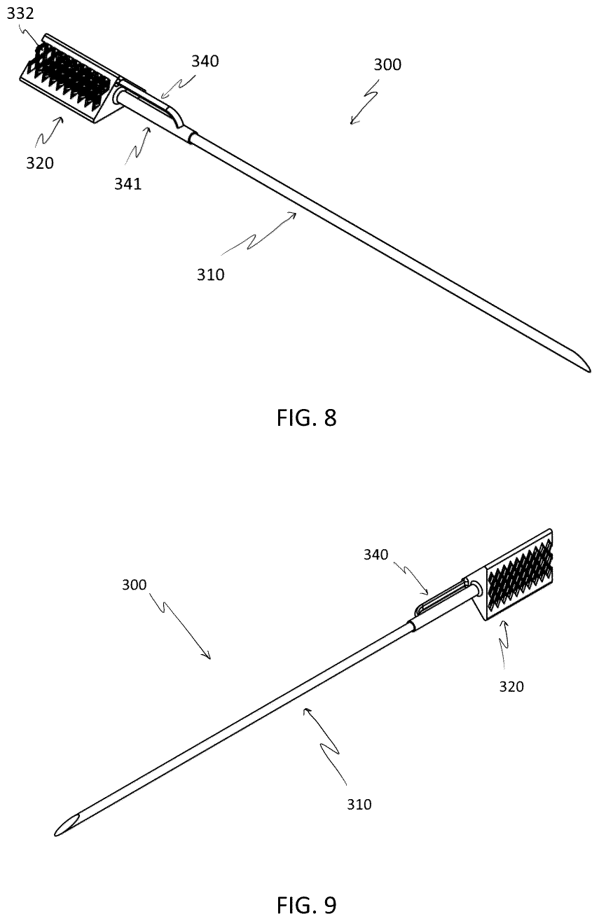

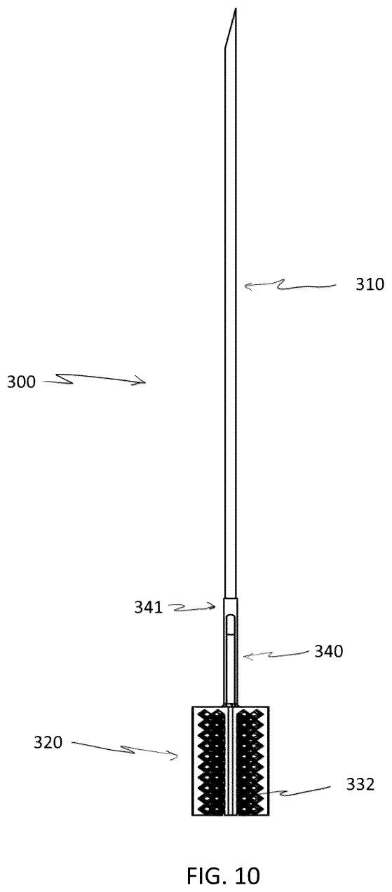

FIGS. 8-10 show another alternate embodiment of the stabilizing bar 300. In this embodiment, the stabilizing bar 300 includes an optional handle 340. One or more handles 340 may be present, or the handle 340 may be entirely absent. The handle 340 may be connected to the shaft 310, to the step cage 320, or extend between the step cage 320 and the shaft 310 or another feature of the stabilizing bar 300, as shown.

As previously discussed, different materials may be used for all or some of the components of the stabilizing bar 300. The shaft 310 may be made of metal, wood, composite, or other suitable materials. The step cage 320 and/or the handle 340, if present, may also be made of different materials. In the embodiment shown, the step cage 320 is made of a rubber-like material and may be molded, machined, or made through additive manufacturing, optionally unitary with the handle. As shown, the step cage 320 further includes a sleeve 341 configured to at least partially receive the shaft 310 while being connected, as shown here, to the step cage 320 . . .

The step cage 320 may optionally define or include one or more openings 332, such as for drainage, to reduce weight, or to create large traction surfaces. In the embodiment shown, the step cage 320 has a plurality of openings which pass through the step cage outer walls into a substantially open inner volume, creating an appearance that is more web-like than solid, while retaining sufficient strength to support a user and anticipated loads and also to, though the section of material defining the openings 332, create a gripping surface to either aid in retaining a user's traction/boots, to aid in stabilization against a roof, or both. It should be noted that, in the embodiment shown, the cage 320 optionally does not include additional or separate gripping teeth 126, though such teeth 126 or other additional gripping features could be included without deviating from the scope or intent of this disclosure.

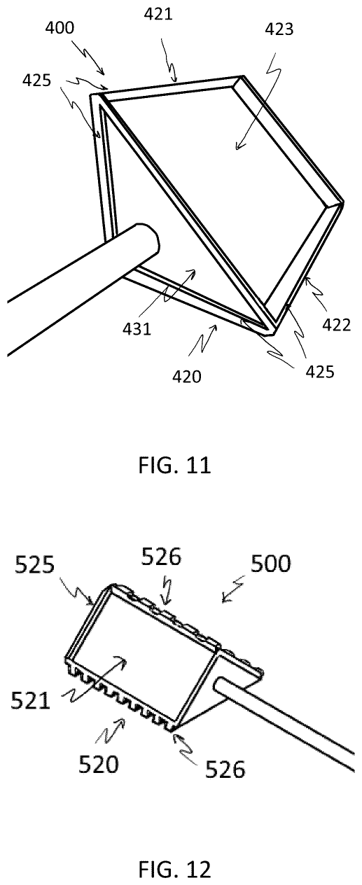

Another embodiment of the stabilizing bar 400 is shown in FIG. 11. In the embodiment shown, the step cage 420 comprises a proximal wall 431 which, like optionally other surfaces of the cage 420, may be recessed at least partially within the cage 420. The cage 420 further includes a bottom surface 423. The bottom surface 423 is shown recessed within the cage 420, though it should be understood that, in other embodiments, it may be flush with the side of the cage 420 that may contact a roof during use. The sides 423, 421, 422 may optionally include weldments 425 or other proud features 425.

FIG. 12 shows another embodiment of the stabilizing bar 500. In the embodiment shown, the step base 520 includes option ridges 525, such as at the edges of one or more faces or surfaces 521, which may aid in retaining a user's foot or boot on the step base 520. The step base 520 may also, additionally or separately, include optional gripping teeth 526, which may optionally be located on one or more sides 521, such as to allow a user to use the stabilizing bar 500 in different rotational orientations relative to a roof.

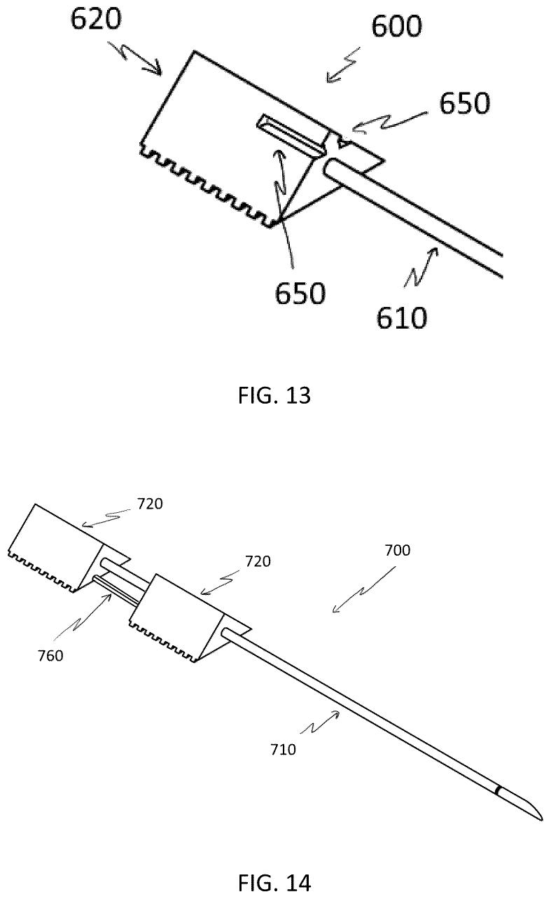

An alternate embodiment of the stabilizing bar 600 is shown in FIG. 13. In the embodiment shown, the step base 620 optionally includes one or more notches 650. Though there are two notches 650 shown in the step base 620, it should be understood that there could be fewer notches 650, there could be more notches 650, or one or more of the notches 650 could be defined in a different portion or feature of the stabilizing bar 600, without deviating from the scope or intent of this disclosure. As shown, the notches 650 are configured to receive the forked end of a Halligan tool. A Halligan tool is a common tool used by fire fighters, and may be removably connected to an axe by means of the forked end or, as designed and shown in the present embodiment, may be connected to a stabilizing bar 600 to aid in carrying, as a single connected grouping of tools, potentially in one hand, some of the required tools by a user. It should be understood that the stabilizing bar 600 may include, comprise, or define other features, such as other notches, holes, recesses, rings, or connecting features, to aid in hanging or connecting other tools, such as hanging tools, axes, or chainsaws, from the shaft 610 or from optional features, such as rings, clips, or other features of the stabilizing bar 600.

FIG. 14 shows another alternate embodiment of the stabilizing bar 700. In the embodiment shown, the stabilizing bar 700 includes two step cages 720. In some situations, it may be preferable to have a second step cage 720 to provide for a greater number of options for foot placement, or in order to straddle a feature of a roof, such as a vent, window, or fan. The second step cage 720 may be integral to the stabilizer bar 700, as shown, or may be removably attachable to the stabilizer bar 700, such as by means of sliding the cage 720 onto a shaft 710 portion of the stabilizer bar 700, clicking it into position, or otherwise removably connecting the second cage 720 to the device 700. In some embodiments, the second cage 720 may be slidable or otherwise may be configured to vary the relative position and distance between the two cages 720, such as, by way of one exemplary embodiment, the two cages 720 may be adjacent and proximal to each other, and then, depending on need, one cage 720 may be slid or otherwise moved or relocated to a different position, creating a spacing and a gap between the two cages 720. In the embodiment shown, the stabilizing bar 700 includes an optional rail 760 extending between the two cages 720. The rail 760 may optionally function as a handle to aid in carrying the stabilizing bar 700, may optionally functioned as a feature from which other items or tools may be suspected or to which other items or tools may be connected, may optionally be a rail that aids in alignment of the second cage 720 when the two cages 720 are slid apart or otherwise have the distance between the two cages 720 increased or varied, or may serve other functional purposes as desired.

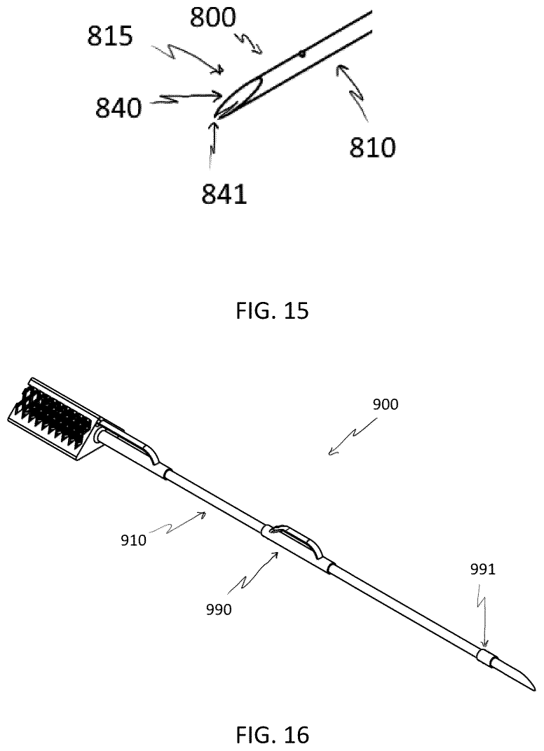

Another alternate embodiment of a stabilizing bar 800 is shown in FIG. 15. In the embodiment shown, the stabilizing bar 800 includes an optional forked feature 841 at the chiselled tip 840 of the distal end 815 of the shaft 810. The forked feature 841 may be used for similar purposes as the forked end of a Halligan tool, may be used in place of a Halligan tool, or may be used for other beneficial purposes. There may also be more than one forked feature 841, or functionally similar feature 841, on the stabilizing bar 800, and the stabilizing bar 800 may optionally include or not include a chiselled tip 840 while optionally including one or more forked features 841 without deviating from the scope or intent of this disclosure.

FIG. 16 shows another alternate embodiment of the stabilizing bar 900. In this embodiment, the stabilizing bar 900 may optionally include an additional hammering feature 990. The hammering feature 990 may include a surface to provide area for hitting with a hammer, such as a sledge hammer or a part of an axe, or may be a slap hammer 990, which, in one optional embodiment, may be slid along the shaft 910 and struck against a surface, such as a hammering stop 991, exerting force to hammer the bar 900 into something, such as in between elements that a user may desire to pry apart, such as a door and a door frame.

In some embodiments of the stabilizing bar 100, the step cage 120 may be made of multiple pieces of stamped stainless steel sheeting which are welded together. It should be understood that, in other embodiments, other means of connection of components may also or alternatively be used, or surfaces of elements of the stabilizing bar 100, such as the step cage 120, may be formed through bending of sheet metal or other materials. Forms may be used to repeatably bend sheet metal in some embodiments and methods of manufacture. In some embodiments, the shaft 110 may pass through a hole in an inner wall of the step cage 120 and extend to the inside surface of the outer wall of the step cage 120. The shaft 110 may be welded to the inner wall, outer wall, other surfaces of the step cage 120, or connected through means other than welding.

Elements and features of the stabilizing bar 100, 200, 300, 400, 500, 600, 700, 800, 900 as described and reasonably to be inferred by one of skill in the art have been described as optional and may be mixed, removed, or modified, in conjunction with depicted embodiments and without, in varying combinations according to this disclosure. Rubber step cages and step cages of similar materials, as well as steel and metal step cages and similar material step cages are shown. Features may be mixed and combined, or entirely absent, such as one or more handles which may be rubber, steel, or similar materials, gripping teeth on one side, multiple sides, or no sides of a step cage, multiple step cages, various teeth and rims or edges, and rounded, flat, or angled surfaces, edges, and corners.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

What is claimed is:

1. A support device, comprising:
a structural connection feature; and
a foot support feature;
wherein the structural connection feature is configured to removably connect to a ladder, and further wherein the foot support feature is offset laterally from the ladder while the support device is removably connected to the ladder and while the support device is in a deployed configuration.

2. The support device according to claim 1, further wherein the support device further comprises an elongated member, and further wherein the elongated member comprises the structural connection feature, and further wherein the elongated member defines a first axis extending from a first end of the elongated member to a second end of the elongated member, the ladder defines a second axis extending from a top end of the ladder to a bottom end of the ladder, and the first axis is substantially perpendicular to the second axis when the support device is in the deployed configuration.

3. The support device according to claim 1, further wherein the structural connection feature is a shaft which is configured to be at least partially received within a first opening defined by a rung of the ladder.

4. The support device according to claim 3, further wherein the structural connection feature is configured to be slidably connected to the rung of the ladder, and further wherein the structural connection feature may pass at least partially through the rung of the ladder.

5. The support device according to claim 3, further comprising a support base which comprises the foot support feature.

6. The support device according to claim 5, further wherein the support based comprises a first surface with a first edge, a second surface with a second edge, and a first roof contact feature.

7. The support device according to claim 6, further wherein the first surface of the support base has at least one protrusion configured to improve traction of a user's foot on the first surface of the support base.

8. The support device according to claim 6, further wherein the first surface of the support base defines at least one opening configured to aid in drainage of liquids from the first surface of the support base.

9. The support device according to claim 6, further wherein the support base has at least one at least partially open face configured to be at least partially seated against a roof.

10. The support device according to claim 6, further wherein the support base has at least one tooth protrusion configured to be pressed against a roof.

11. The support device according to claim 6, further wherein the support base is substantially triangular in cross-section.

12. The support device according to claim 11, further wherein the shaft defines a pointed feature at a first end distal to the support base.

13. The support device according to claim 11, further wherein the shaft comprises a locking feature configured to resist motion of the shaft relative to the ladder once the support device is removably connected to the ladder in a desired orientation.

14. The support device according to claim 11, further comprising a handle proximal to the support base.

15. A method of using a support device, comprising:
placing at least a portion of a shaft of the support device at least partially within a hole of a rung of a ladder;
adjusting the location of a support base feature of the support device at a desired distance from the ladder;
standing on a first surface of the support base with one foot; and
cutting an opening in a roof of a building.

16. The method of using a support device according to claim 15, further comprising the step of placing the ladder against the roof of a building.

17. The method of using a support device according to claim 16, further comprising the step of orienting a second gripping surface of the support base against the roof.

18. The method of using a support device according to claim 17, further comprising the step of locking the support device in a desired orientation relative to the ladder.

19. The method of using a support device according to claim 17, further wherein the first surface of the support base has at least one traction protrusion.

20. The method of using a support device according to claim 17, further wherein the first surface of the support base defines at least one opening.
